(19) United States
(12) Patent Application Publication
(10) Pub. No.: US 2009/0019536 A1
(43) Pub. Date: Jan. 15, 2009

(54) AUTOMATIC IP NETWORK DETERMINATION AND CONFIGURATION FOR EDGE DEVICES

(75) Inventors: James Nicholas Green, Cambridge (GB); Jonathan Edward Vernon Custance, Cambridge (GB)

Correspondence Address: Levenfeld Pearlstein, LLC;Intellectual Property Department, 2 North LaSalle, Suite 1300, Chicago, IL, 60602, US

(73) Assignee: CAMRIVOX LTD., Cambridge (UK)

(21) Appl. No.: 12/162,279

(22) PCT Filed: Jan. 29, 2007
(86) PCT No.: PCT/GB07/00293

§ 371 Date: Sep. 10, 2008

(30) Foreign Application Priority Data
Jan. 27, 2006 (GB) 0601706.5
Jan. 29, 2007 (GB) PCT/GB07/00293

(51) Int. Cl. G06F 15/177; G06F 21/00

(52) U.S. Cl. 726/12; 709/221

(57) ABSTRACT

A method of self-configuration of a network device having at least one network connection port, comprising the steps of, after booting of the network device, actively probing a network in which the network device is located and analysing data packets received on the port(s), attempting to determine a network configuration for all network connections the device can make according to information extracted from the received data packets, and configuring device settings according to the network configuration determined.

### FIELD OF THE INVENTION

The present invention relates to the problem of deploying network electronic products within an existing networked environment without requiring configuration input from the end user. Additionally, the present invention relates to the problem of deploying network electronic devices within an existing networked environment having a network access device that may limit or restrict the connection of a Local Area Network (LAN) to a Wide Area Network (WAN).

### BACKGROUND TO THE INVENTION

In a basic home or business setup, an edge device on a LAN, that is a device at the edge of the LAN, for example a Personal Computer (PC), is connected to a WAN interface device. The WAN interface device may be in the form of a cable or Digital Subscriber Line (DSL) modem or router. The WAN interface device enables the connection of the LAN to a WAN such that the LAN edge device can communicate with devices on the WAN.

For the LAN edge device, or indeed any other intermediate or “embedded” LAN devices, to communicate with devices on the WAN, specifically the Internet, it must have the following information:
Its own Internet Protocol (IP) address
The IP address of the WAN interface device to enable communication between the LAN device and the WAN interface device, termed gateway IP address
The IP address of a Domain Name Server (DNS) to enable communication with “named” devices on the Internet

There are a number of protocols or mechanisms today that enable a LAN device to automatically acquire, or to be statically configured, with this information and also protocols or mechanisms that configure part of this information. Two mechanisms are commonly used today to determine the IP addresses. Dynamic Host Configuration Protocol (DHCP) is a client/server-based protocol for assigning IP addresses on an IP network automatically. Alternatively, the IP addresses can be manually or statically configured.

There are also a number of other mechanisms such as AutoIP that deal with the automatic assignment of IP addresses for the LAN device itself, but do not address the WAN interface device and Domain Name Server addressing.

Network Address Translation (NAT) is a mechanism that allows a single public IP address, i.e. an address unique within the Internet, to be shared by a plurality of LAN devices using private IP addresses, i.e. addresses not used to communicate directly with other devices on the Internet, in order for the LAN devices to communicate with devices on the Internet. With “full” NAT, a DSL modem, for example, will use a public IP address whilst a PC, for example, has a private IP address. No sharing of addresses occurs with full NAT. In simple deployment scenarios, and in particular Digital Subscriber Line deployments, it is common to use something termed “half-NAT”. Half-NAT enables a DSL modem, for example, and a single PC to share a common public IP address. This overcomes a problem in that NAT can cause problems since protocols that communicate over IP often embed logical IP address(es) of edge devices within the communication.

DSL deployments may use a variety of protocols to connect the WAN interface device to the WAN. A number of solutions exist to automatically determine which network protocol is used by the WAN. The WAN interface device, i.e. the gateway or router, is subsequently configured to use this protocol to automatically determine the network addressing required and to allow connection of the WAN interface device to the WAN.

Where a LAN device is an embedded/edge LAN device, such as an IP phone, it may function either as an edge LAN device or an embedded LAN device. As an embedded LAN device, it is connected between an edge LAN device and a WAN interface device, or directly to the Internet. Accordingly, the embedded/edge LAN device has both a WAN network port for connection to the WAN interface device, and a LAN network port for connection to the edge LAN device.

The DSL Forum (www.dslforum.org) provides protocols to configure the WAN and LAN network ports of embedded/edge LAN devices. This requires a specific protocol to be implemented by the device in order to be configured. However, such configuration does not take into account the existing network in which the device sits and will not work on networks other than those using DSL WAN interface devices. It is also a client-server based model and requires investment on the part of the service provider

It is common for many embedded/edge LAN devices that provide additional services to a LAN to have a plurality of LAN network ports to which a user can connect other LAN devices, such as networked PCs.

Some known WAN interface devices limit the number of LAN devices that can connect to a WAN via the WAN interface device. This is usually achieved by limiting the number of devices that can connect through the WAN interface device to services such as DHCP. This is often implemented by limiting access to the first Media Access Control (MAC) address seen on the LAN by the WAN interface device.

In these situations known embedded/edge LAN devices typically either ask the user what type of WAN interface device they are connected to and the MAC address of their PC, or require the user to purchase an additional “NAT-router” to connect the WAN and the LAN. The user will often have to configure this router with the MAC address of their PC or “power-cycle” the WAN interface device. In both cases the embedded/edge LAN devices will configure NAT. This could cause problems for the end user after the device is installed as some protocols may now cease to work.

A majority of end users are not familiar with terms such as “DHCP”, “IP address” and “MAC address” and hence many networked consumer electronic products are hard for users to “deploy” and start using. As mentioned above, known products require the end user to specifically configure certain modes of operation and typically only offer DHCP by default. Users often do not know details of particular WAN interface devices. Users also can become frustrated when networked devices, which were working perfectly well before, do not continue to work when they install new devices on the network, even more so when further hardware is necessary to correct such problems.

In addition end users are frequently confused by the installation of such devices and can inadvertently connect the WAN and LAN network ports to the incorrect networks, i.e. connecting the LAN port to the WAN, and the WAN port to the LAN. Currently available devices fail to operate in this circumstance. The known problems of communication over IP, such as voice-over IP (VoIP), and NAT, which many such devices default to, have yet to be adequately addressed.

This creates a significant support burden for operators deploying such devices and affects the take up of new technologies due to the complication and fear factor these devices create with end users.

### SUMMARY OF THE INVENTION

According to a first aspect of the present invention, a method of self-configuration of a network device having at least one network connection port, comprises the steps of:

(i) after booting of the network device, actively probing a network in which the network device is located and analysing data packets received on the port(s);

(ii) attempting to determine a network configuration for all network connections the device can make according to information extracted from the received data packets; and

(iii) configuring device settings according to the network configuration determined.

The method in accordance with the first aspect of the present invention is advantageous in that it can eliminate end user configuration of the network device by automatically determining the setup of an existing, or new, networked environment in which the network device has been installed. Once sufficient information regarding the setup of the networked environment is known the network device can self-configure according to the network environment setup. In this manner a user need have no networking knowledge to properly install the network device, and may have the same experience before and after the device is connected to an existing networked environment.

In a preferred embodiment of the present invention, the network device is an edge device that does not perform the function of a router. The device settings to be self-configured include the local IP address to be assigned to the device from free IP addresses available on the local subnet at the device's location. In addition, the IP and MAC addresses of a gateway through which the device can connect to a WAN, and a DNS server address can be identified and self-configured so that the device can make connections to the Internet.

In the preferred embodiment the device further includes a storage device containing an executable code, wherein the device is adapted to execute the code to perform the method in accordance with the first aspect of the present invention. The storage device preferably contains a plurality of predetermined network setting types and by execution of the code one type of the network configuration may be selected from these predetermined types. Possible network configuration types include DHCP and DHCP where the number of physical devices on the LAN in which the device is located is limited by a network access device, so-called limited MAC DHCP. The self-configuration may alternatively include obtaining IP addresses based on the setup of local devices. In addition, the configuration may be semi-automatic, or even fully manual, where the information required for full self-configuration is not available to the device, or is not possible.

To enable self-configuration, the preferred device for implementing the method of the first aspect of the present invention should be resilient to such conditions as “incorrect” connection of network cables, the order in which other devices in the network environment are “powered-up”, and changes in the network environment. This resilience is provided in the form of a number of algorithms that may be included in the executable code such that the device can cope with many situations prior art devices cannot. For example, by identifying a gateway through which the device is connected to a WAN, the device port associated with the gateway can be determined. The device can therefore be configured according to the functionality of the port rather than the physical location of the port in the device.

The method may be adapted to execute a routine such that a case where a user incorrectly connects two ports of the device together in a “loop-back”, one or other or both of the ports so connected is automatically disabled.

The method may be further adapted to build up a database of information related to the network environment. In this way, the order in which the device and other devices in the network environment are “powered-up” becomes of little relevance in the method of the first aspect of the present invention. This database may be stored, for example in a storage device, for later interrogation in the self-configuration routine, or the information therein may be used in the device configuration “on-the-fly”.

As the network environment of the device changes, for example, as other devices are added or removed, network addresses become available or are taken up, and devices are powered on and off, one or more of the steps of the method of the first aspect of the present invention may be started, paused, stopped and/or restarted as necessary to ensure the device remains correctly configured, automatically where possible.

To build the database of information related to the network environment identified above, the method of the first aspect of the present invention could include steps of identifying and analysing packets received on the device ports. This packet analysis could retrieve information from packet headers relating to source and destination IP and MAC addresses, for example, to be used to determine the presence and status of particular devices in the network such as a DNS server, gateway, modem, router or PC.

Once a successful device configuration has been established; this configuration may be stored in the method of the first aspect of the present invention such that it is saved over a hard reset of the network device. This saved configuration may then be subsequently tested as a potential shortcut to full re-configuration of the device.

According to a second aspect of the present invention, a method of determining port connectivity for a network device having at least two network connection ports, wherein one of the ports is connected to a WAN, comprises the steps of:

identifying a gateway through which the device is connected to the WAN; and

determining through which of the ports information is conveyed to and from the gateway.

According to a third aspect of the present invention, a method of self-configuration of a network device, comprises the steps of:

obtaining, from a storage device, a previous network configuration for the device;

checking the previous network configuration to ascertain whether or not the configuration is still valid;

configuring device settings according to the network configuration if the validity check is positive; and

attempting to determine a new network configuration for the device and configuring device settings according to the new network configuration if the validity check is negative.

According to a fourth aspect of the present invention, a method of self-configuration of a network device connected between a first network device and a second network device, comprises the steps of:

attempting to determine a network configuration for the network device; and

configuring device settings of the network device such that the first network device appears, to the second network device, to be connected to the second network device, and the second network device appears, to the first network device, to be connected to the first network device.

According to a fifth aspect of the present invention, a method of self-configuration of a network device having at least two network connection ports, the method comprises the steps of:

passively snooping a network in which the network device is located and analysing data packets received on the ports;

determining information relating to a DNS server connected to the device according to information contained in data packets received on the ports; and

configuring device settings according to the DNS server information determined.

According to a sixth aspect of the present invention, a method of self-configuration of a network device having at least one network connection port comprises the steps of:

determining information relating to a gateway and a DNS server connected to the device according to information contained in data packets received on the port(s); and

configuring device settings according to the gateway and DNS server information determined to enable the device to connect to the Internet.

According to a seventh aspect of the present invention, a self-configuring network device has a storage device containing an executable code, wherein the device is adapted to execute the code to perform the method in accordance with any one or more of the first to sixth aspects of the present invention.

### BRIEF DESCRIPTION OF THE DRAWINGS

Examples of the present invention will now be described in more detail with reference to the accompanying drawings, in which:

FIG. 1 shows a schematic diagram of an exemplary embedded LAN device implementing the present invention;

FIG. 2 shows the connection terminals of the device of FIG. 1;

FIGS. 3a and 3b show an example of a network configuration before and after installation of the device of FIG. 1, respectively;

FIG. 4 shows a flow diagram of a packet analysis routine performed by the device of FIG. 1;

FIG. 5 shows a flow diagram of a database structure stored in the device of FIG. 1;

FIGS. 6a and 6b show a flow diagram of a probing and interrogation routine performed by the device of FIG. 1;

FIG. 7 shows a flow diagram of a WAN port determination routine performed during the probing and interrogation routine;

FIG. 8 shows a flow diagram of a “Normal DHCP” device mode implementation;

FIG. 9 shows a schematic diagram of the device of FIG. 1 connected in a “Limited MAC DHCP” mode;

FIG. 10 shows detail of an ideal arrangement of a device connected in a “Limited MAC DHCP” mode;

FIG. 11 shows detail of an actual arrangement of the device of FIG. 1 connected in “Limited MAC DHCP” mode;

FIG. 12 shows a flow diagram of device operation in Limited MAC DHCP mode for a packet received on the LAN port;

FIG. 13 shows a flow diagram of device operation in Limited MAC DHCP mode for a packet to be sent from the LAN port;

FIG. 14 shows a flow diagram of device operation in Limited MAC DHCP mode for a packet to be sent from the WAN port;

FIG. 15 shows a flow diagram of device operation in Limited MAC DHCP mode for a packet received on the WAN port; and

FIG. 16 shows a flow diagram of routine interoperation for device configuration.

### DETAILED DESCRIPTION

### Exemplary Device

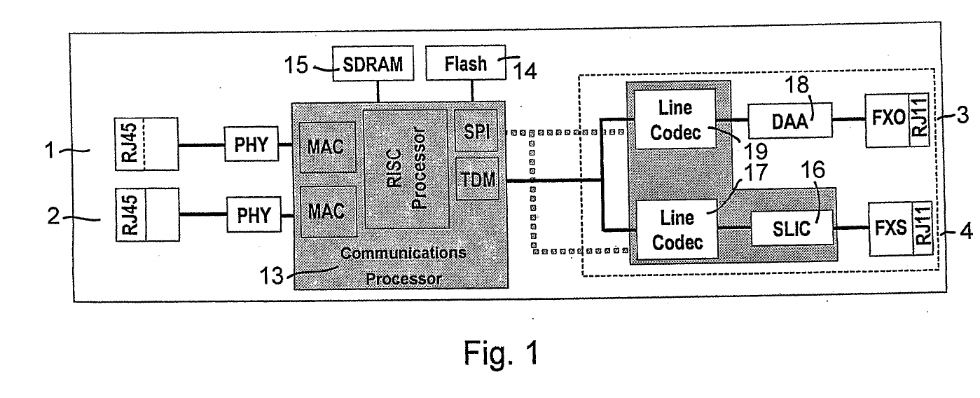

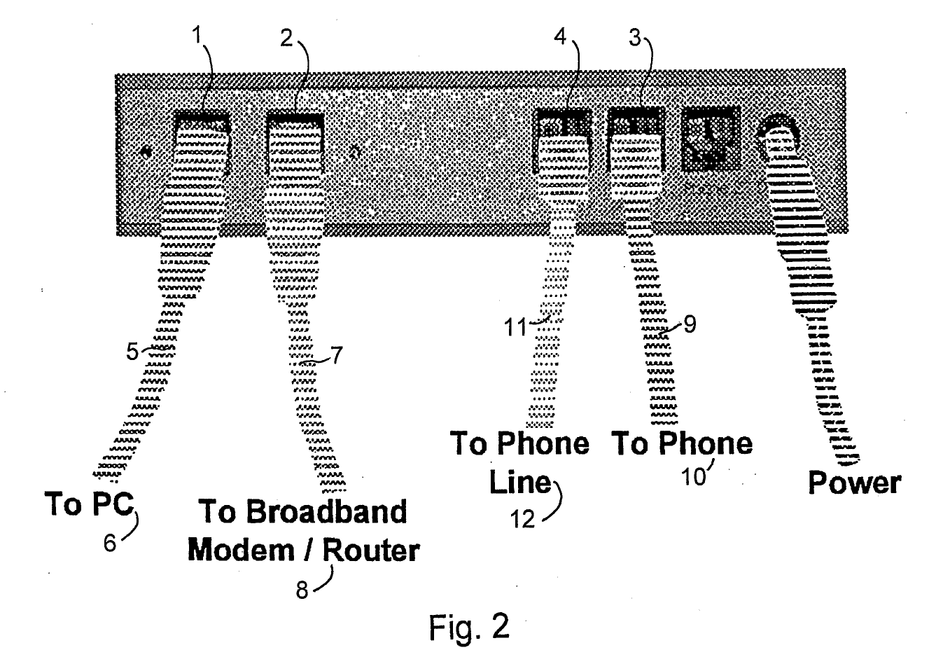

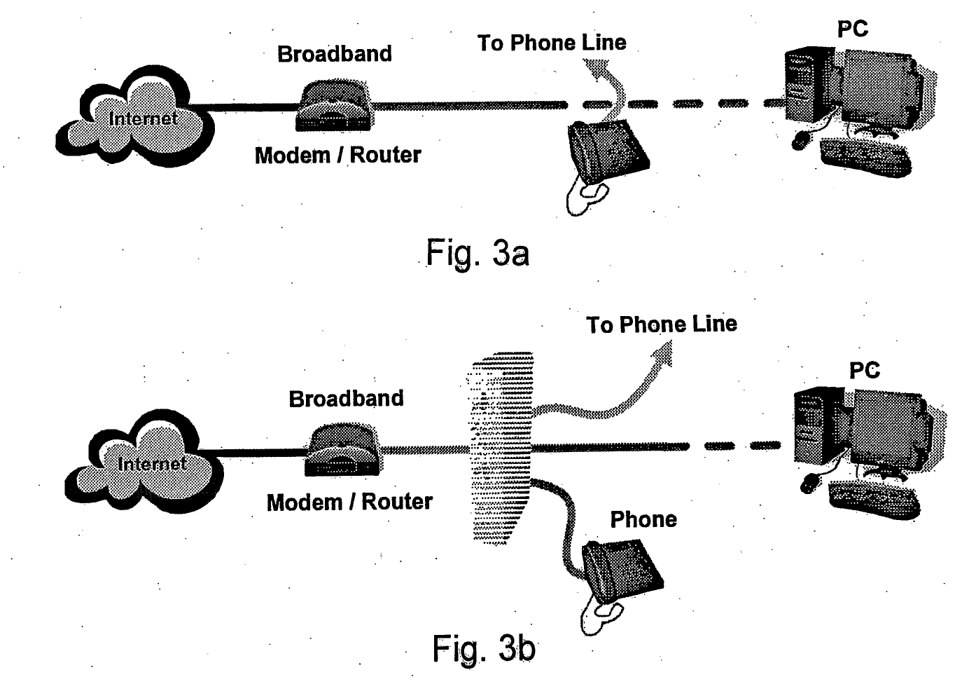

The exemplary device of FIG. 1 comprises a LAN port 1, a WAN port 2, a telephone port 3 and a telephone line port 4. In the setup of FIGS. 2 and 3b a first Ethernet cable 5 is connected between a PC 6 and the LAN port 1, and a second Ethernet cable 7 is connected between a broadband modem/router 8 and the WAN port 2. A first telephone cable 9 is connected between a telephone 10 and the telephone port 3, and a second telephone cable 11 is connected between a telephone line 12 and the telephone line port 4. The LAN and WAN ports 1,2 have RJ45 type connectors and the telephone and telephone line ports 3,4 have RJ11 type connectors.

The LAN and WAN ports 1,2 are connected via respective physical layers (PHYs) to a communications processor 13. The communications processor 13 includes a Reduced Instruction Set Computer (RISC) processor, two Media Access Controllers (MACs), a Serial Peripheral Interface (SPI) and a Time Division Multiplexer (TDM). The communications processor 13 is connected to two storage devices 14,15. The first storage device is a non-volatile “Flash” storage 14, which is used to permanently hold software to be executed by the communications processor 13 and also to hold any configuration information relating to the device and its surroundings that is required by the software to be permanently stored. The Flash 14 interfaces with the communications processor 13 via a parallel interface. The second storage device is Synchronous Dynamic Random Access Memory (SDRAM) 15. When the device is powered on, the communications processor 13 executes the software in the Flash 14 and copies the run time software into SDRAM 15. SDRAM 15 is then used for program execution and volatile data storage at run time.

The telephone port 3 is connected via a Subscriber Line Interface Circuit (SLIC) 16 to a first line Coder-Decoder (CODEC) 17. The line CODEC 17 provides an interface between the telephone 10 connected to the telephone port 3 and digital telephony. The telephone line port 4 is connected via a Data Access Arrangement (DAA) 18 to a second line CODEC 19. The line CODEC 19 provides an interface between the telephone line 12 connected to the telephone line port 4 and digital telephony. The DAA 18 provides electrical isolation of the telephone line 12 from the device whilst enabling physical connection between these entities. The communications processor 13 configures and controls the line CODECs 17,19 via the SPI. The communications processor 13 also sends and receives voice samples using the TDM interface.

The communications processor 13 executes all software required to perform the operations of the device including drivers to control all of the external interfaces, including the ports 1 to 4, drivers to control all internal peripherals, including the Flash 14 and SDRAM 15, an Operating System (OS), IP communication, Voice-Over IP (VoIP) signalling software, and voice CODECs and algorithms.

In addition to the specific device components mentioned above, the device further includes a power supply connection, General Purpose Input Output (GPIO) pins including interrupts, LEDs, buttons and others as will be appreciated by those skilled in the art.

Upon installing the device, for example as shown in FIG. 3b, and described above, and connecting a power cable to the power supply connection and switching on the device, the communications processor 13 executes software stored in the Flash 14, as described previously. Next will be described details of device operation upon executing the parts of the software related to the present invention.

### Packet Analysis

The first operation performed relates to the initialisation of an analysis routine for analysing packets of data received on the LAN and WAN ports 1,2 in order to initialise or update a database of information relating to the networks. The database is stored in the SDRAM 15. The software code relating to packet analysis receives copies of all network packets received on LAN and WAN ports 1,2. The code uses this information to initialise or update entries in the database.

The code uses the port information to determine what, if any, MAC addresses have been seen on each port 1,2; IP address(es) that are associated with each observed MAC address; and properties associated with the MAC addresses and IP addresses. The port information is entered into the database having the following entry fields: a list of the device ports; a list of MAC addresses per port; a list of IP addresses per MAC address; and a list of the properties associated with the ports, MAC addresses and IP addresses.

From time to time (described further in the following “Probing and Interrogation” section) the device issues “loopback” packets, which it sends out from each of the ports 1,2. These loopback packets are identifier packets, which are unlike any other packets that will be received on the ports 1,2. The purpose of the loopback packets is to enable the device to determine whether or not one of the ports 1,2 is connected to another of the ports 1,2. If, for example, the device is installed such that an Ethernet cable has its one end connected to the LAN port 1 and its other end connected to the WAN port 2 then a loopback packet sent out from either port will be routed back and received on the other of the ports. The packet analysis routine is configured to handle such loopback packets as well as packets more typically received on the WAN and LAN.

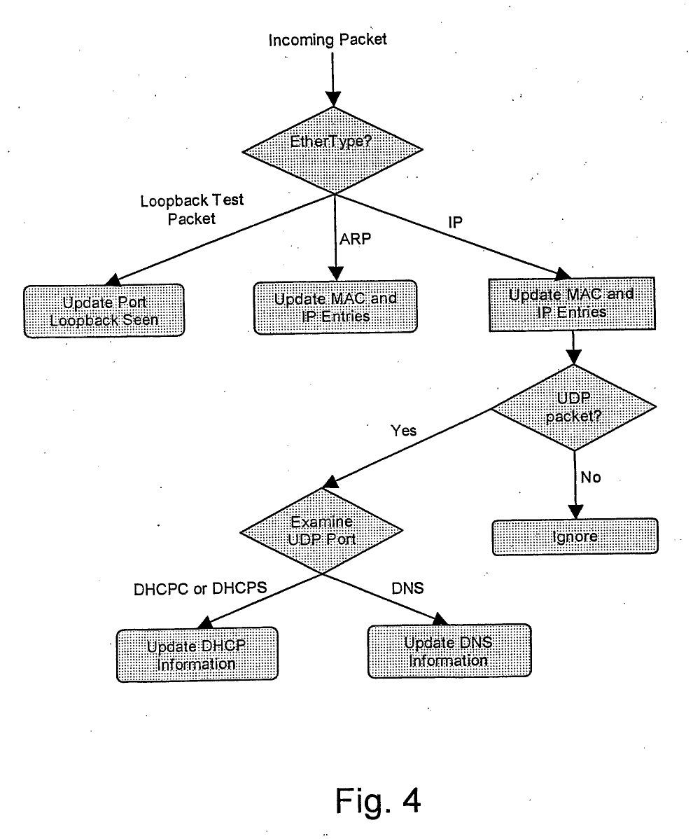

A flow chart of the analysis process is shown in FIG. 4. A packet received on one of the ports 1,2 is checked for its, so-called, Ether type. Four generic Ether types are discriminated. Type 1 is the loopback test packet described above. Type 2 is an Address Resolution Protocol (ARP) packet which allows a physical network address (such as a MAC address) to be determined if a logical network address (such as an IP address) is known. Type 3 is an IP packet and type 4 is all other packets.

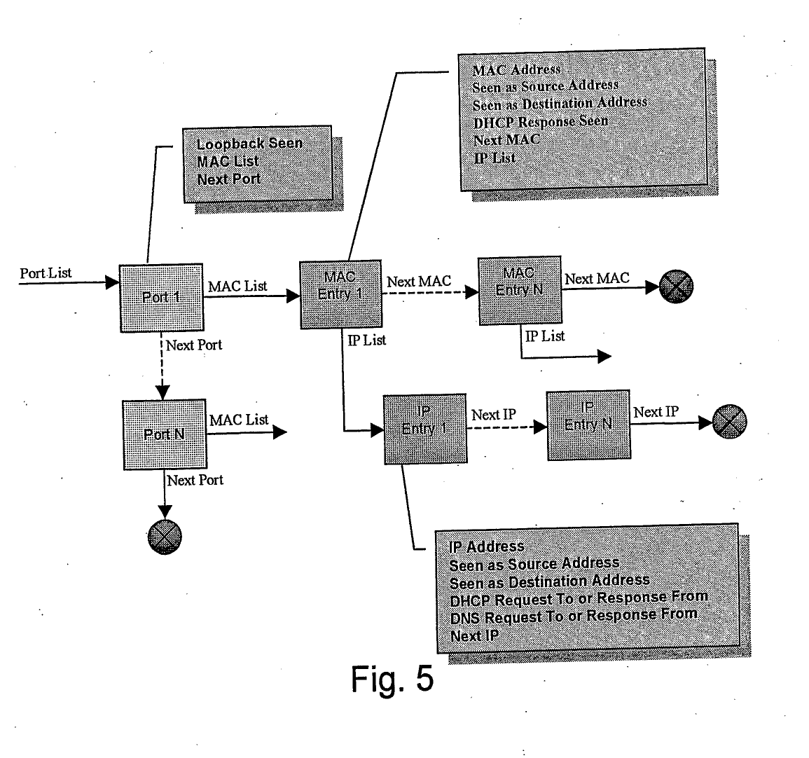

The packet analysis routine runs continuously to ensure the network information database is up-to-date. FIG. 5 illustrates the database structure and together with FIG. 4 illustrates how the database entries are initialised or updated.

As shown in FIG. 4, an incoming packet on a particular port is first checked for its Ether type. If the Ether type is type 1, a loopback test packet, then the port properties list in the database is updated to reflect the loopback status for the port the packet was received upon. The device may use the loopback status entries in the database to disable a particular port, as will be described in the following section. No entries in the MAC or IP address lists will appear against the port having a positive loopback status and the routine immediately moves to detect any incoming packets on the next port, as shown in FIG. 5.

If the Ether type is type 2, an ARP packet, or type 3, an IP packet, then the information in the packet is used to update MAC and IP entries in the database. First, as shown in FIG. 5, the database MAC list for the port the packet was received upon is updated with the MAC address of the received packet. If this is the first MAC entry in the database for that port then this address in entered as MAC Entry 1 in the MAC list. The routine checks whether the MAC address was seen as a source or a destination MAC address and stores this information in the MAC properties list against MAC Entry 1 in the database. Furthermore, the routine checks whether the packet contains a DHCP response for this MAC address and sets a DHCP response flag accordingly in the MAC properties list. If a different MAC address has previously been stored as MAC Entry 1 then the above MAC address and associated MAC properties are stored in the next available MAC Entry location in the database. For the received MAC address the routine also checks for an associated IP address seen in the packet, as well as whether this was seen as a source or destination IP address. This information is stored in the IP address and IP address properties lists in the database under IP Entry 1. If a different IP address has previously been stored as IP Entry 1 then the above IP address and associated IP properties are stored in the next available IP Entry location in the database.

If the Ether type is type 3, the routine further checks whether or not the IP packet is a User Datagram Protocol (UDP) packet. This further check is shown schematically in the flow diagram of FIG. 4. If it is not a UDP packet then no further information to that described above is stored in the database for that packet. If the packet is a UDP packet then a check is made as to whether the packet was a DHCP server (DHCPS), a DHCP client (DHCPC), or a DNS packet. The IP properties list in the database stores details of whether a MAC response has been seen for the particular MAC address, whether a DHCP request or response has gone to or from the particular IP address, or whether a DNS server request or response has gone to or from the IP address, and sets flags accordingly.

All other packets are considered as type 4 and are ignored by the routine for the purposes of initialising or updating the database.

The database information is used by a probing and interrogation software code held in the Flash 14 and executed by the communications processor 13. Operations performed by execution of the probing and interrogation code are described below. The size of the database is limited to prevent memory usage problems on the device.

### Probing and Interrogation

The probing and interrogation code carries out a series of tests, which result in packets being transmitted, and subsequently the database interrogated in order to determine the network setup. The probing and interrogation routine can be stopped, paused/restarted and started afresh under the control of an external agent. For example, starting afresh would happen if any significant change occurred to the network, for example disconnection of the broadband/modem router 8, no further response from a DHCP server, or no response from a gateway for a prolonged period of time.

An object of the probing and interrogation routine to determine which of the ports 1,2 has been connected to the LAN and WAN, irrespective of any port designation on the device itself. For example, if the “LAN” port 1 as designated on the device is actually connected via Ethernet cable 7 to the broadband modem/router 8, and the “WAN” port 2 as designated on the device is actually connected via Ethernet cable 5 to PC 6, then the routine is operable to effectively redefine the ports such that during device configuration port 1 becomes the WAN port and port 2 becomes the LAN port. This is a particular, though not exclusive, problem where, as in the exemplary device embodiment of the implementation of the present invention, the same type of cable connectors may be fitted to ports 1 and 2 of the device.

The routine also has the object of determining whether or not DHCP is being used on the network, and if so which of the ports 1,2 the DHCP server is operating on. If DHCP is being used, the routine also detects whether or not the network places a limitation on the number of MAC addresses that can be supported on it with a view to device configuration, described in the following section.

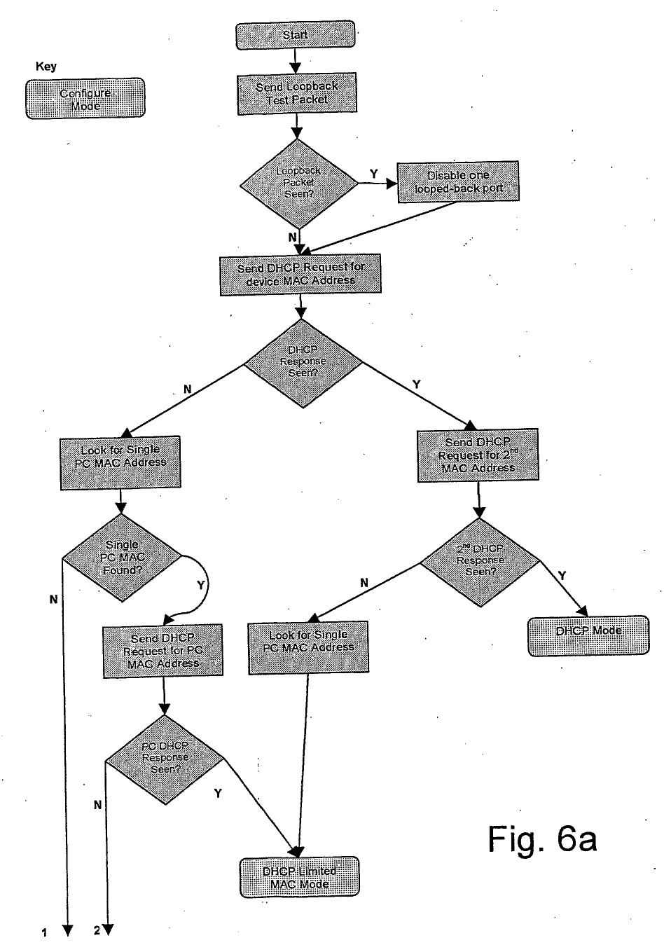

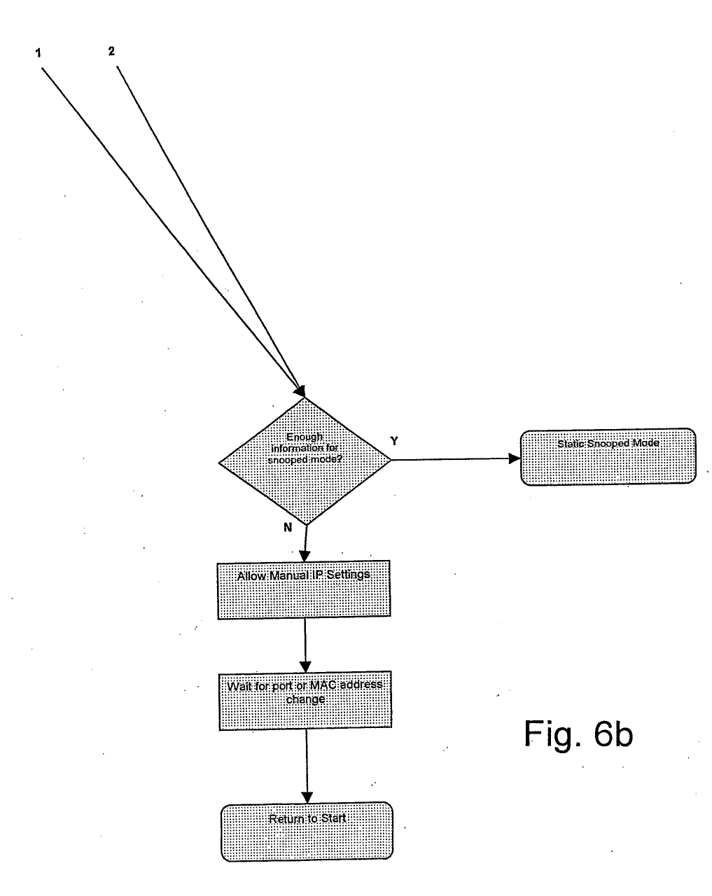

Tests performed by the probing and interrogation routine will now be described with reference to FIGS. 6a and 6b.

As mentioned in the previous section, the device issues loopback test packets to see if the ports 1,2 are connected in any way. The probing and interrogation routine instigates the issuance of these packets, waits for a short period of time, and then interrogates the database to see if any port has seen this packet. If the packet is received on one of the ports 1,2 then it is disabled.

Assuming that a loopback packet has not been seen then the routine continues and sends a DHCP request to detect for a DHCP server on the network. After issuing the DHCP request, the routine waits for a predetermined period of time and then looks in the database for a response from a DHCP server to the request. Details of how the DHCP response is stored in the database appear in the previous section.

If a DHCP server is detected then two potential DHCP device configurations may be possible. A further test is therefore performed to ascertain which of these is suitable before proceeding to execute the device configuration routine. The device may be configurable in either a “Normal DHCP” mode or in a “Limited MAC DHCP” mode. In the first scenario, there is no limit on the number of MAC addresses available on the network. In the second scenario, there is a network limit on the number of MAC addresses but the MAC address of the device itself happens to be the first MAC address observed (for example if the PC 6 attached to the device is not powered on).

The further test consists of sending a DHCP request using a second device MAC address. If a response to the second DHCP request is seen then the device assumes there is no limit on the number of MAC addresses available, at least in so far as it is possible for the MAC address of the device itself to exist on the network. In this case, the routine elects “Normal DHCP” mode, which result is detected and used in the device configuration routine described in the following section.

If no response to the second DHCP request is seen then the routine performs further checks to see if the MAC address of an attached PC 6 can be detected. Irrespective of the outcome of these further checks, the routine elects “Limited MAC DHCP” mode, which result is detected and used in the device configuration routine described in the following section.

If no DHCP server is detected in response to the original DHCP server request, then there are two potential reasons for this. Either there is no DHCP server, or there is a DHCP server but there is a limit on the number of MAC addresses on the network and the MAC address of the attached PC 6, for example, has already been noted by the broadband modem/router 8, for example, hence it does not respond to the DHCP server request.

In order to determine whether or not there exists a DHCP server, the routine performs a further check to see if it can determine the MAC address of the attached PC 6. If this further check is successful then the routine tests whether a DHCP server responds to the MAC address of the attached PC in a similar way to that described above. If a DHCP response to the PC MAC address is seen then the routine elects “Limited MAC DHCP” mode, which result is detected and used in the device configuration routine described in the following section.

If no PC MAC address can be found, or if no DHCP response is seen in response to the PC MAC address if found, then the routine determines whether the information obtained thus far is sufficient for either an alternative self-configuration mode using information from the database, or a manual configuration if there is insufficient information in the database, or whether the probing and interrogation routine is to restart. The self-configuration and manual configuration modes will be described in the following section. If a significant change, as described previously, is detected on the network then the probing and interrogation routine will be restarted.

The final step of the probing and interrogation routine is to determine which of the ports 1,2 is the WAN port. As mentioned previously, the exemplary device has one LAN port 1 and one WAN port 2. However, the skilled person will appreciate that a plurality of LAN ports 1 may be provided. In either case a single WAN port 2 is provided and so it is necessary to determine which of the ports 1,2 has actually been connected to the WAN, irrespective of the port designation on the device.

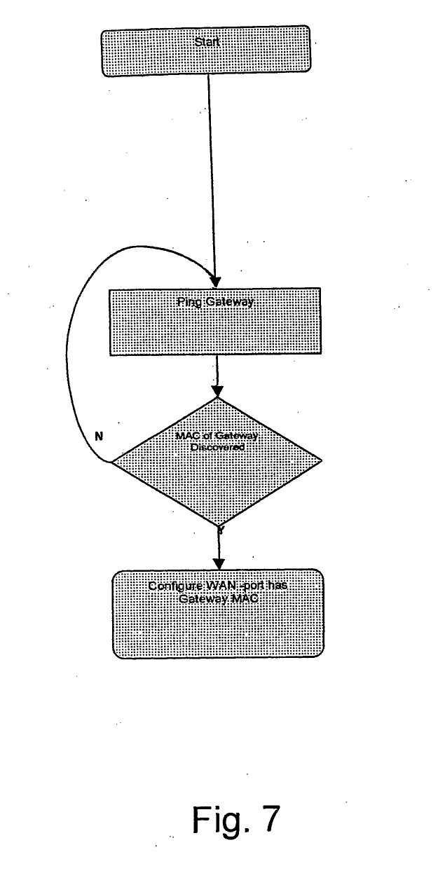

FIG. 7 shows a flow diagram of the WAN port determination. The WAN port is determined by sending an Internet Control Message Protocol (ICMP) request with a predetermined time-to-live, for example, one, to the determined broadband modem/router 8 MAC address. The device then receives and identifies an ARP request from the gateway, responds to the ARP request to enable the gateway to send a response to the network device identifying that the time-to-live of the ping request has expired. Upon receipt of the time-to-live expired response from the gateway, the device can determine the gateway IP address from this received time-to-live expired response. Based on which of the device ports 1,2 this time-to-live expired response is received, the WAN port can also be determined.

The probing and interrogation routine is monitored by a probing control code, which monitors a physical connectivity status of the device interfaces, i.e. the LAN and WAN ports 1,2. This monitoring is performed continuously to monitor when new devices are physically connected to, or disconnected from, the device interfaces. Any significant changes to the physical connectivity status of the device interfaces causes the probing control code to order a restart of the probing and interrogation routine to redefine the port status and the device configuration mode.

In case of transient problems detected during running of the probing and interrogation routine, the probing control code may pause the routine. If after successful device configuration, as will be described in the following section, the IP networking connectivity subsequently fails, the probing control code may also act to reset the probing and interrogation routine to its default state (i.e. an empty database) and restart the routine.

The probing and interrogation routine therefore attempts to determine the port status, the WAN port, and the device configuration mode.

### Device Configuration

Similar to the software routines described above, a device configuration routine is stored in the Flash 14. Once the probing and interrogation routine has completed for the first time, the device configuration routine is executed. The device configuration routine has as its object to configure the device's IP and physical interface settings.

If the packet analysis and probing and interrogation routines have been able to determine sufficient information, the device configuration routine configures the device IP settings to enable the device to connect to the Internet. The device configuration routine consists of configuring the device physical interfaces and IP settings, storing the current configuration settings in the database, and informing the probing and interrogation routine to determine the WAN interface. Once the WAN interface has been determined the device configuration routine continues and configures the physical interfaces, and configures Quality of Service settings on the WAN interface before finally storing the current configuration in the database.

If the probing and interrogation routine has not been able to determine sufficient information, an error message is generated and manual, conventional, user input is required to configure the device in a static configuration.

In the following, it is assumed that the routines have been able to determine sufficient information for one of the above described self-configuration modes to be implemented to configure the device. These configuration modes will now be described in detail.

### Normal DHCP Mode

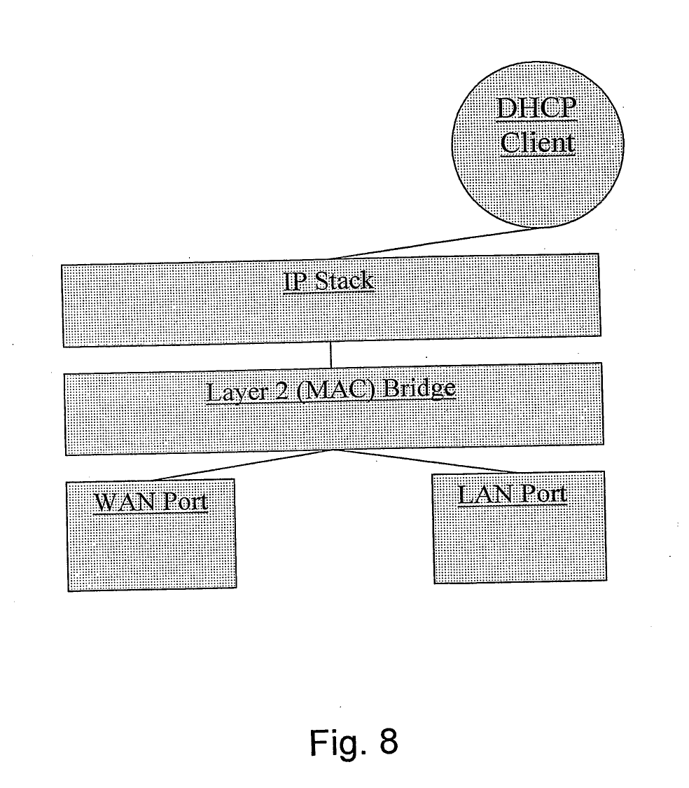

In unrestricted, normal DHCP mode, all device ports 1,2 are connected to a Layer 2 Bridge. The bridge is connected to a single IP interface on which there is a DHCP client to determine network configuration settings. This is summarised by FIG. 8. Since there is no restriction on the number of MAC addresses available through the broadband modem/router 8, the device configuration is straightforward and all information required may be readily obtained during running of the setup routines described above. The device may therefore be simply plugged in and the PC user experience will remain unchanged after device installation as before.

### Limited MAC DHCP Mode

The object of this mode is to configure the device such that one half of the device acts as the PC 6 to the broadband modem/router 8 and the other half of the device acts as the broadband modem/router 8 to the PC 6. The effect of this is that each half of the device mirrors the MAC and IP addresses of the device (i.e. PC 6 or broadband modem/router 8) that is connected to the other half.

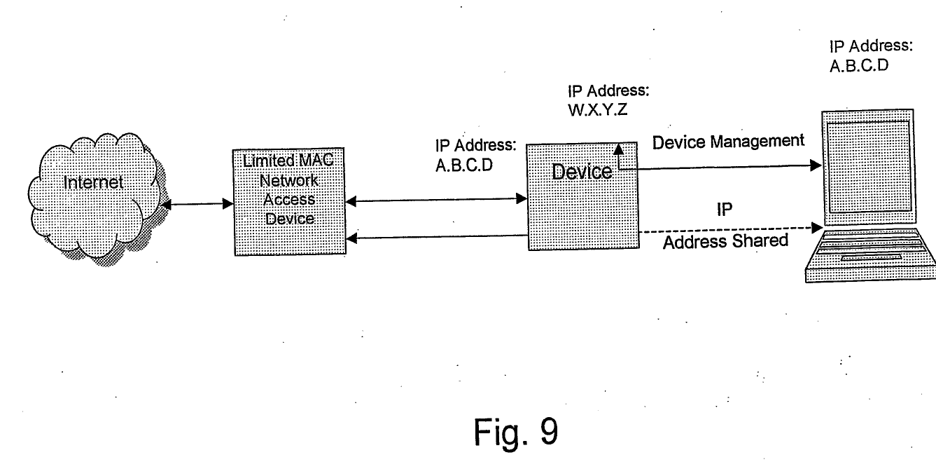

A schematic of the implemented device arrangement is shown in FIG. 9. The broadband modem/router 8 operating in Limited MAC DHCP mode is connected to the Internet and to one side of the device. The PC 6 is connected to the other side of the device. The device is configured such that the broadband modem/router 8 “sees” the PC 6, and the PC 6 “sees” the broadband modem/router 8 as if the device wasn't there. By this setup, despite the limited number of MAC addresses available through the broadband modem/router 8, the PC user experience remains unchanged after device installation as before.

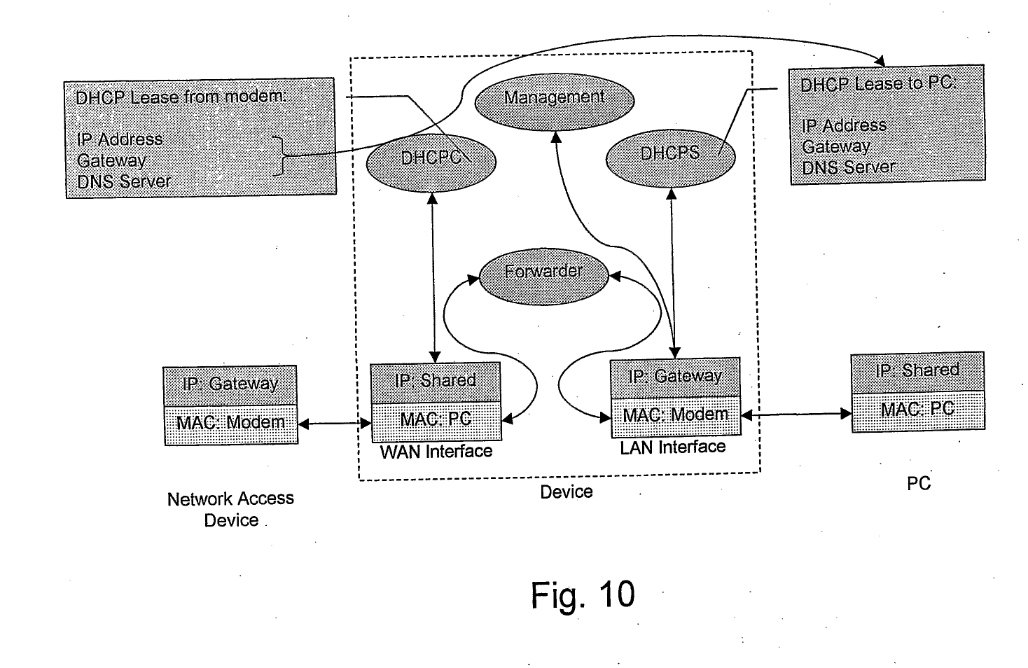

A simple ideal implementation of this configuration mode is shown in detail in FIG. 10. The mirroring effect achieved by this configuration mode is evident from the assignment of MAC and IP addresses to the PC, device and network access device. The device is configured with two IP stacks, with interfaces attached to the LAN and WAN ports. The WAN side IP stack is connected to a DHCP Client (to obtain network configuration) and also to a forwarder. The LAN side IP stack is connected to a DHCP Server, which is able to provide the PC or router on the LAN with the same network configuration that the WAN port received via its DHCP client. In the diagram DHCP Lease is a term used to describe the network configuration received from a server or passed to a client. The LAN side IP stack is also connected to the forwarder and management.

The PC “sees” the LAN side of the device as if it is the network access device since it appears having the IP address of the gateway and the MAC address of the modem. The network access device “sees” the WAN side of the device as if it is the PC since it appears having the shared IP address of the PC and the MAC address of the PC.

The forwarder merely passes packets from WAN interface to LAN interface and vice-versa. However, if the network access device sees the MAC address of the device first (i.e. Limited MAC DHCP mode is entered because no second DHCP response was received during the probing and interrogation routine) then it is also necessary to translate MAC addresses between the device MAC address and the PC MAC address when packets pass between the LAN and WAN via the forwarder. Whilst this ideal implementation is valid for a number of device applications, the exemplary device in accordance with the embodiment of the present invention requires a higher level of complexity due to some software constraints. Accordingly, the following description refers to an actual implementation of this configuration mode with reference to the ideal model described above.

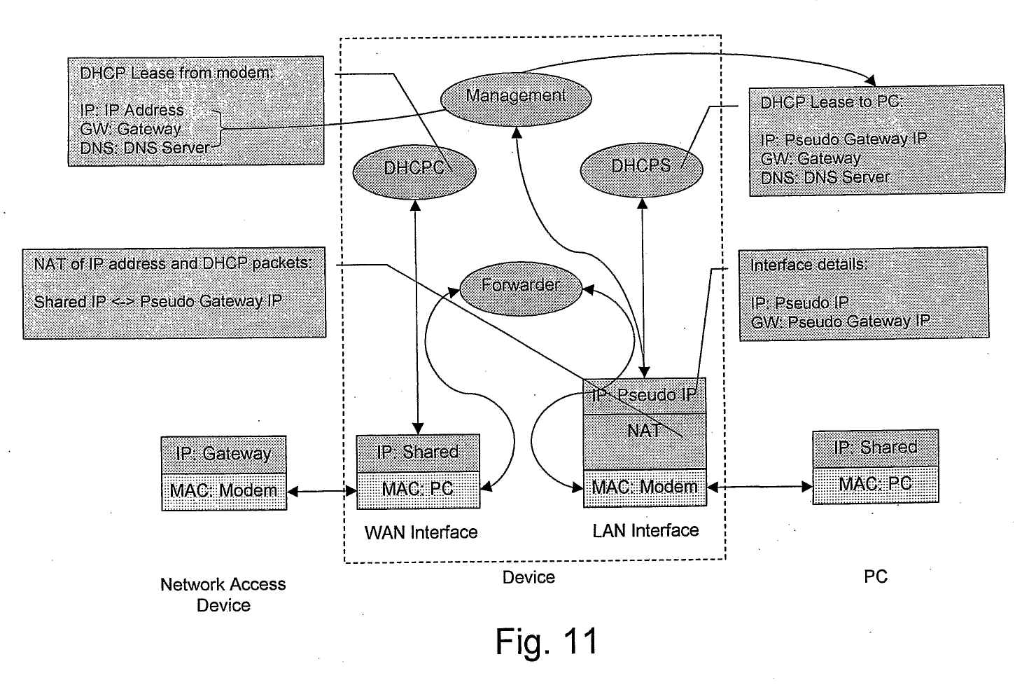

Implementation of the Limited MAC DCHP configuration mode on the exemplary device in accordance with the embodiment of the present invention will now be described with reference to FIG. 11. The requirement for this is that the device has a single IP stack to which both ports are connected. As can be seen from comparing FIGS. 10 and 11, in the arrangement of FIG. 11 the LAN IP interface effectively sits between a NAT engine and the physical LAN port 1. This allows the logical IP interface to use a different, pseudo IP address, rather than that used by the network access device on the WAN side. At the “MAC” level the forwarder is used to directly transfer information between the WAN and LAN interfaces. The single IP stack can communicate with both interfaces in a coherent manner and allows management of the device and DHCP configuration of the attached PC. The NAT engine translates between this pseudo IP address used by the LAN port 1 and the shared IP address that is required by the PC 6 to connect through to the network device 8. The NAT translates addresses in the IP headers and also the contents of any DHCP packets. The pseudo IP address can also be used to manage the device from the LAN without conflicting with management of the network access device 8 on the WAN side. The NAT engine does not affect packets destined from the broadband access device to the PC and vice-versa. Processing by this arrangement will now be described.

In order to process packets received on the WAN and LAN ports 1,2 appropriately the following information is required and maintained by the configuration mode, and stored in the database: MAC addresses of the device WAN and LAN ports 1,2, broadband gateway/router 8, PC 6 (this may not be known at start of configuration process, for which see below); information on whether the broadband gateway/router 8 has stored the MAC addresses of the device or PC 6; and IP addresses of the broadband gateway/router 8, and shared and pseudo IP addresses.

As discussed previously, it is possible that in executing the probing and interrogation routine, Limited MAC DHCP mode was correctly selected but the PC 6 connected to the LAN port 1 of the device is not powered on or connected. In this scenario the routine checking received packets on the LAN port 1 adopts the first MAC address seen on the LAN port 1 as the PC 6 MAC address (this has been omitted from diagrams and following description for clarity of the general case).

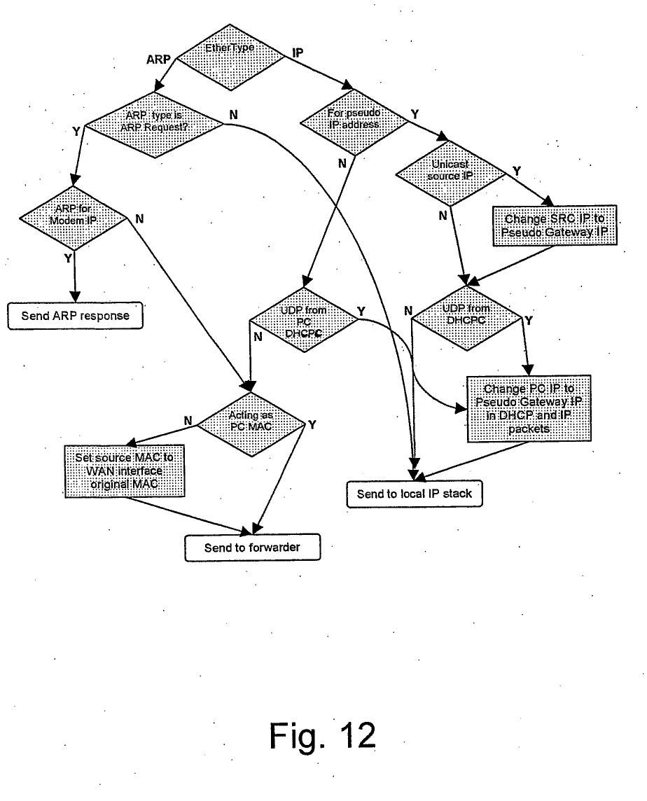

Operation of Limited MAC DHCP mode will now be described with reference to FIGS. 12 to 15 relating to 4 operational cases, namely: packet received on the LAN port 1; packet to be sent from the LAN port 1 as a result of transmission from the local IP stack; packet to be sent from the WAN port 2 as a result of transmission from the local IP stack; and packet received on WAN port 2.

Packets send to the forwarder by the LAN port are immediately sent via the WAN port and vice-versa.

Turning first to FIG. 12 there is shown a flow diagram of processing performed for a packet received on LAN port 1. Firstly, as in previous routines, it is judged what is the Ether type of the received packet, i.e. ARP or IP.

If the packet is an ARP packet and is an ARP request for the IP address of the broadband modem/router 8, then an appropriate ARP response is to be sent with information to reply to the request.

If the packet is an ARP packet and is an ARP request for another device, then this request is sent to the forwarder. If the device MAC address is being used on the WAN interface, then the MAC address of the PC 6 from which the ARP packet was received is replaced with the device MAC address before sending to the forwarder.

If the packet is an ARP packet but is not an ARP request packet, then the packet is sent to the local IP stack.

If the packet is an IP packet and is destined for the pseudo IP address (and hence the local IP stack) and is from a, so-called, unicast IP source address, then NAT is applied to the packet headers to change the source (SRC) IP address to the pseudo gateway IP address. If the packet is a UDP DHCP client packet then NAT is applied to the packet to change the PC 6 IP address to the pseudo gateway IP address in the DHCP and IP packets. After application of any applicable NAT rules the packet is sent to the local IP stack.

If the packet is an IP packet but is not destined for the pseudo IP address (and hence not for the local IP stack) and it is not a packet from a DHCP client, then the packet is sent to the forwarder. If the device MAC address is being used on the WAN interface, then the MAC address of the PC 6 from which the IP packet was received is replaced with the device MAC address before sending to the forwarder.

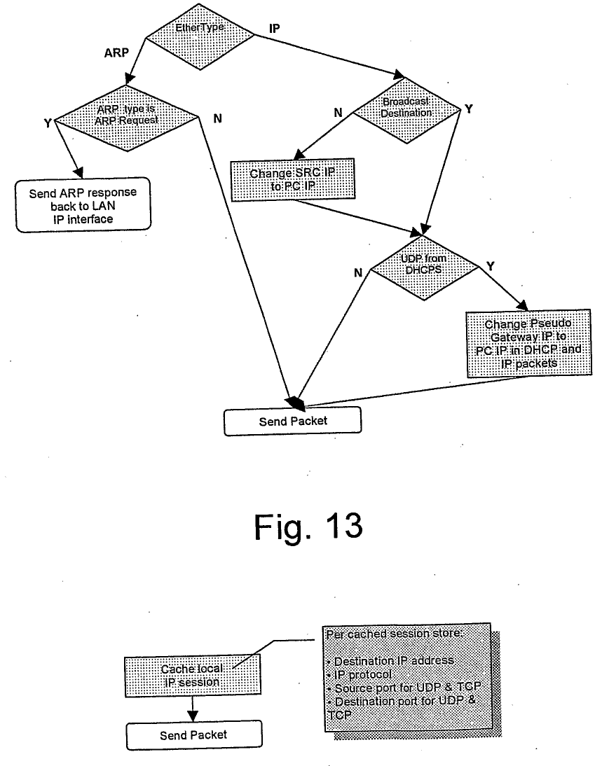

Turning next to FIG. 13 there is shown a flow diagram of processing performed for a packet to be sent from LAN port 1 as a result of transmission by the local IP stack. Again, it is judged what is the Ether type of the packet to be sent, i.e. ARP or IP.

If the packet is an ARP packet and is an ARP request, then an ARP response is sent back to the LAN IP stack. If the packet is any other ARP packet, then this is transmitted out of the LAN port 1.

If the packet is an IP packet, but does not have a broadcast destination address, then NAT is applied to the headers to change the SRC IP address to the PC 6 IP address. If the packet is from a DHCP server, then NAT is applied to the packet to change the pseudo gateway IP address to the PC 6 IP address. After application of any applicable NAT rules the packet is transmitted out of the LAN port 1.

Turning next to FIG. 14 there is shown a flow diagram of processing performed for a packet to be sent from WAN port 2 as a result of transmission by the local IP stack. Again, it is judged what is the Ether type of the packet to be sent, i.e. ARP or IP.

All packets that are transmitted from the device are ‘cached’ by storing information about each session prior to transmission. Multiple IP sessions are recorded enabling multiple services from the device. Sessions are limited (in terms of total number) and also time-out after a set period of time. This limits any potential interactions with LAN side traffic. The information stored per session relates to the destination IP address (compared with source IP address on receive), the IP protocol, the source port (compared with destination port on receive), and the destination port (compared with source port on receive).

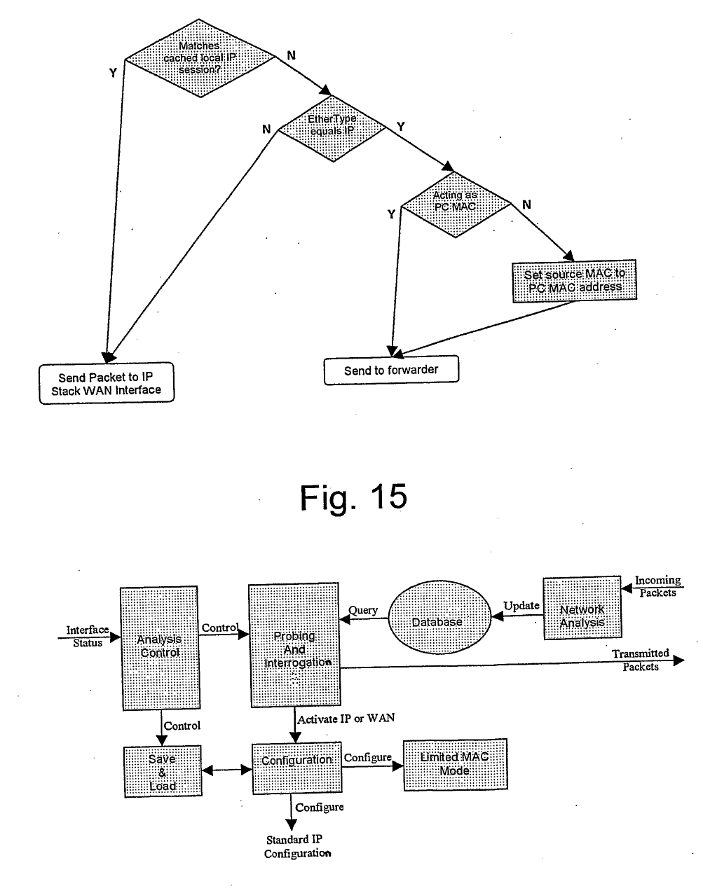

Finally, turning to FIG. 15 there is shown a flow diagram of processing performed for a packet received on WAN port 2. On reception the packet is first matched against a cached session. If a match is found the packet is passed to the WAN IP stack. If the packet did not match and the packet was not an IP packet it is also passed to the WAN IP stack. All other packets are passed to the forwarder. Prior to doing so, if the MAC address of the device is being used on the WAN interface, then this MAC address is replaced with that of the PC 6.

Packets sent to the forwarder by the LAN port are immediately sent via the WAN port and vice-versa.

### Static Snooped Mode

The object of this mode is to statically configure the IP addresses based partially on information stored in the database and by trialling potential IP addresses for the device to complete the configuration.

From the packet analysis routine, a number of network settings of the broadband modem/router 8 (gateway), DNS server and local subnet and IP address will be stored in the database.

In order for the database to hold all the required information it is necessary to have seen/snooped packets containing particular information. This is enabled by the fact that the device has both WAN and LAN ports 1,2 and sees all packets forwarded between them by the forwarder.

The broadband modem/router 8 can be identified by looking through the database of network information for a MAC address having multiple destination IP addresses associated with it. The MAC address will be that of the broadband modem/router 8. Once the broadband modem/router 8 has been identified, the local subnet can be determined.

Once the MAC address of the broadband modem/router 8 has been identified, its local IP address (which may not have been already snooped) can be determined. This is done by sending the broadband modem/router 8 a packet with a time-to-live (TTL) of 1, containing a destination IP addresses that is further upstream in the network. The broadband modem/router 8 will respond with an ICMP reply containing its IP address on the local subnet.

Once the local subnet is known, it is possible to ‘try’ potential IP addresses for the device using ARPs to see if the IP address is already used on the subnet. The device ARPs to find free IP addresses on the local subnet. It assumes a Class C subnet of the form A.B.C.X, and tries all valid values of X until no clash is found. If the entire subnet is allocated, then the device stops the configuration process. If a free address is found the device can be configured.

The DNS server can easily be identified by searching for DNS packets from clients wanting to resolve an address. The server address will be the destination IP address in the packet.

### State Saving and Restoration

Once the device is configured, the configuration is stored in a database in Flash. On restart the device will read the saved configuration from Flash and configure the device accordingly. If this configuration is still satisfactory, then nothing more is done. If it is not then the probing control routine will start the probing and interrogation routine, which may subsequently lead to a new configuration.

### Static IP Address Configuration—Safe Mode

If it is not possible to automatically configure the device, it is still desirable to be able to contact it over the network. The device therefore has provision for by-passing all of the above configuration routines, and instead configures the device with a fixed fail-safe IP address. Such an address could be a private IP address such as 192.168.1.1 or 10.0.0.1. This safe mode could be entered if, for example, the user held down a button on the device as it is turned on.

An overview of the device configuration routines is shown in the flow diagram of FIG. 16. This diagram illustrates how the device interfaces and packets received or transmitted thereon are used to configure the device.

In addition to the purely exemplary embodiment of the present invention as described above, it will be appreciated by those skilled in the art that various modifications and alternatives are envisaged within the scope of the invention which is defined by the appended claims.

For example, the packet analysis and probing could be combined, eliminating the need for a database of results. Instead, the device configuration could be implemented or updated directly according to the device status. This option, though, would be less flexible than the embodiment described above.

Each possible configuration mode could be tested in parallel, to speed up configuration determination. This would only require a minor increase in processing power but the programmatic complexity would increase significantly and so this option was not chosen for the embodiment of the invention described above.

Rather than the half-NAT option chosen for the Limited MAC mode described above, full NAT could be employed. However, NAT would affect the end user experience as all inbound applications would stop working and some outbound applications may be affected.

As an alternative to using DHCP client and server in the Limited MAC mode, it would be possible to ‘snoop’ the DHCP information travelling between the broadband modem/router 8 and the PC 6 and use this as the addressing information for the device. This was rejected for the specific embodiment described above since this fails in the case where the broadband modem/router 8 learns the MAC address of the device.

Point to Point Protocol over Ethernet (PPPoE) is a protocol used by some cable operators to provide connectivity between a PC or home/business router and a network access device. In the case where the device of the exemplary embodiment described above is connected between the PC or router and the network access device, PPPoE may be detected in the same way that DHCP is detected in the above embodiment, by sending out a packet and analysing the result. Detection of this configuration scenario has not been implemented in the exemplary device but it is envisaged that this will be an add-on feature for future devices. In this situation there would be an additional mode PPPoE configuration mode.

In the particular embodiment described above, the ports 1 and 2 are Ethernet ports. However, the present invention has applicability to many other port types such as BlueTooth(®); ZigBee(®); Ethernet-like ports; 802.11; Powerline(®); HomePlug(®); and UWB.

Whilst the present invention has been described with reference to the exemplary device above it will be appreciated by those skilled in the art that the aspects of the invention may be applied to any embedded/edge device connected between a network access device and a router or PC, for example.

1. A method of self-configuration of a network device having at least one network connection port, comprising the steps of:
(i) after booting of the network device, actively probing a network in which the network device is located and analysing data packets received on the port(s);
(ii) attempting to determine a network configuration for all network connections the device can make according to information extracted from the received data packets; and
(iii) configuring device settings according to the network configuration determined.

2. A method according to claim 1, wherein the device has at least two network connection ports, and the active probing of step (i) includes the steps of:
sending a data packet of a predetermined type from one of the ports; and
monitoring the ports,
and wherein step (iii) includes disabling the port from which the packet was sent and/or the port on which the packet was received, if the data packet is subsequently received on another of the ports.

3. A method according to claim 1, wherein the network device has at least two network connection ports, one of which is connected to a Wide Area Network (WAN), and wherein steps (i) and (ii) include the step of determining port connectivity by performing the steps of:
identifying a gateway through which the device is connected to the WAN; and
determining through which of the ports information is conveyed to and from the gateway.

4. A method according to claim 3, wherein the step of determining through which of the ports information is conveyed to and from the gateway comprises the steps of:
sending an Address Resolution Protocol (ARP) request from one of the ports using the identified gateway Internet Protocol (IP) address;
determining a Media Access Control (MAC) address of the gateway from a response to the ARP request received on one of the ports;
sending a ping request to the gateway from one of the ports using the gateway MAC and IP addresses; and
determining which of the ports is connected to the gateway according to which of the ports received a response to the ping request.

5. A method according to claim 1, wherein steps (i) and (ii) include the step of determining information relating to a gateway and a Domain Name Server (DNS) connected to the device according to information contained in data packets received on the port(s); and step (iii) includes the step of configuring device settings according to the gateway and DNS server information determined to enable the device to connect to the Internet.

6. A method according to claim 5, wherein the gateway information is determined from at least two received data packets each containing an identical MAC address and differing destination IP addresses, the MAC address being that of the gateway.

7. A method according to claim 6, wherein steps (i) and (ii) further include the step of determining the IP address of the gateway according to the determined MAC address of the gateway.

8. A method according to claim 7, wherein the step of determining the gateway IP address comprises the steps of:
sending a ping request with a predetermined time-to-live to the determined gateway MAC address;
receiving and identifying an ARP request from the gateway;
responding to the ARP request from the gateway to enable the gateway to send a response to the network device identifying that the time-to-live of the ping request has expired;
receiving and identifying the time-to-live expired response from the gateway; and
determining the gateway IP address from the received time-to-live expired response.

9. A method according to claim 5, wherein the DNS server information is determined from received DNS data packets having as their source IP address the IP address of the DNS server.

10. A method according to claim 7, further comprising the step of determining a free local IP address for the network device.

11. A method according to claim 10, wherein the step of determining a free local IP address for the network device comprises the steps of:
determining a local subnet;
sending an ARP request from one of the ports; and
determining a free local IP address for the network device from a response to the ARP request received on one of the ports.

12. A method according to claim 11, wherein the step of sending an ARP request is sent according to a predetermined sequence of ARP requests until a free local IP address is found.

13. A method according to claim 1, wherein the network device is connected between a first network device and a second network device, and wherein, depending on the network configuration determined, step (iii) includes configuring the device settings such that the first network device appears, to the second network device, to be connected to the second network device; and the second network device appears, to the first network device, to be connected to the first network device.

14. A method according to claim 13, wherein the first network device is a personal computer (PC), and the second network device is a gateway, router or network access device.

15. A method according to claim 1, further comprising the steps of:
obtaining data associated with a previous network configuration, if it exists;
checking the previous network configuration to ascertain whether or not the configuration is still valid; and
if the validity check is positive, omitting steps (i) and (ii) and performing step (iii), otherwise performing steps (i) to (iii).

16. A method according to claim 1, wherein steps (i) and (ii) are performed, repeated and suspended according to external stimuli, including stimuli from the group of stimuli including:
a change in physical connectivity of the network device; and
a change in information received by the network device.

17. A method according to claim 1, wherein if step (ii) fails, the method further comprises the step of manually configuring the device settings.

18. A method according to claim 1, performed automatically upon supplying power to the device.

19. A method according to claim 1, wherein the network device is an edge device that is not a router.

20. A method according to claim 1, wherein the network connection port(s) include ports from the group of port types including: BlueTooth®; ZigBee®; Ethernet-like ports; Ethernet; 802.11; Powerline®; HomePlug®; and UWB.

21. A method according to claim 1, wherein the device settings include settings from the group of settings including:
IP address settings;
MAC address settings; port settings;
gateway address settings;
DNS address settings; and
local network address settings.

22. A method according to claim 1, wherein a type of the network configuration is selected from a plurality of predetermined network setting types.

23. A method according to claim 22, wherein step (iii) comprises configuring software operably connected to the device port(s).

24. A method according to claim 1, further comprising the step of storing data associated with the network configuration in a storage device prior to step (iii).

25. A method according to claim 24, wherein the data is stored in a database in the storage device.

26. A method according to claim 24, wherein the storage device is a Flash memory.

27. A method according to claim 1, wherein steps (ii) and (iii) are performed concurrently.

28. A method of determining port connectivity for a network device having at least two network connection ports, wherein one of the ports is connected to a WAN, comprising the steps of:
identifying a gateway through which the device is connected to the WAN; and
determining through which of the ports information is conveyed to and from the gateway.

29. A method according to claim 28, wherein the step of determining which of the ports is connected to the gateway, comprises the steps of:
sending an ARP request from one of the ports using the gateway IP address;
determining a MAC address of the gateway from a response to the ARP request received on one of the ports;
sending a ping request to the gateway from one of the ports using the gateway MAC and IP addresses; and
determining which of the ports is connected to the gateway according to which of the ports received a response to the ping request.

30. A method of self-configuration of a network device, comprising the steps of:
obtaining, from a storage device, a previous network configuration for the device;
checking the previous network configuration to ascertain whether or not the configuration is still valid;
configuring device settings according to the network configuration if the validity check is positive; and
attempting to determine a new network configuration for the device and configuring device settings according to the new network configuration if the validity check is negative.

31. A method according to claim 30, where the method of any of claims 1 to 27 is performed if the validity check is negative.

32. A method according to claim 30, wherein the storage device is a Flash memory.

33. A method according to claim 30, wherein the network configuration for the device is stored in a database in the storage device.

34. A method of self-configuration of a network device connected between a first network device and a second network device, comprising the steps of:
attempting to determine a network configuration for the network device; and
configuring device settings of the network device such that the first network device appears, to the second network device, to be connected to the second network device, and the second network device appears, to the first network device, to be connected to the first network device.

35. A method according to claim 34, wherein the first network device is a PC, and the second network device is a gateway, router or network access device.

36. A method of self-configuration of a network device having at least two network connection ports, the method comprising the steps of:
passively snooping a network in which the network device is located and analysing data packets received on the ports;
determining information relating to a DNS server connected to the device according to information contained in data packets received on the ports; and
configuring device settings according to the DNS server information determined.

37. A method according to claim 36, wherein the DNS server information is determined from received DNS data packets where:
either the IP address of the DNS server is determined from the source IP address of a DNS response data packet;
or the IP address of the DNS server is determined from the destination IP address of a DNS request data packet.

38. A method of self-configuration of a network device having at least one network connection port, the method comprising the steps of:
determining information relating to a gateway and a DNS server connected to the device according to information contained in data packets received on the port(s); and
configuring device settings according to the gateway and DNS server information determined to enable the device to connect to the Internet.

39. A method according to claim 38, wherein the gateway information is determined from at least two received data packets each containing an identical MAC address and differing destination IP addresses, the MAC address being that of the gateway.

40. A method according to claim 39, wherein the IP address of the gateway is determined according to its determined MAC address.

41. A method according to claim 40, wherein the step of determining the gateway IP address comprises the steps of:
sending a ping request with a predetermined time-to-live to the determined gateway MAC address;
receiving and identifying an ARP request from the gateway;
responding to the ARP request from the gateway to enable the gateway to send a response to the network device identifying that the time-to-live of the ping request has expired;
receiving and identifying the time-to-live expired response from the gateway; and
determining the gateway IP address from the received time-to-live expired response.

42. A method according to claim 38, wherein the DNS server information is determined from received DNS data packets having as their source IP address the IP address of the DNS server.

43. A method according to claim 40, further comprising the step of determining a free local IP address for the network device.

44. A method according to claim 43, wherein the step of determining a free local IP address for the network device comprises the steps of:
determining a local subnet;
sending an ARP request from one of the ports; and
determining a free local IP address for the network device from a response to the ARP request received on one of the ports.

45. A method according to claim 44, wherein the step of sending an ARP request is repeated according to a predetermined sequence of requests until a free local IP address is found.

46. A self-configuring network device having a storage device containing an executable code, wherein the device is adapted to execute the code to perform the method according to any of the preceding claims.
